(19) United States
(12) Patent Application Publication
(10) Pub. No.: US 2025/0029274 A1
(43) Pub. Date: Jan. 23, 2025

(54) OBJECT POSE DETERMINATION SYSTEM AND METHOD

(71) Applicant: TuSimple, Inc., SAN DIEGO, CA (US)

(72) Inventors: Yizhe ZHAO, San Diego, CA (US); Zhe CHEN, San Diego, CA (US); Ye FAN, San Diego, CA (US); Lingting GE, San Diego, CA (US); Zhe HUANG, San Diego, CA (US); Panqu WANG, San Diego, CA (US); Xue MEI, San Diego, CA (US)

(21) Appl. No.: 18/488,657

(22) Filed: Oct. 17, 2023

Related U.S. Application Data
(60) Provisional application No. 63/514,610, filed on Jul. 20, 2023.

(51) Int. Cl. G06T 7/73; G06V 20/58

(52) U.S. Cl. CPC G06T 7/73; G06V 20/58; G06T 2207/30252

(57) ABSTRACT

The present disclosure provides methods and systems of sampling-based object pose determination. An example method includes obtaining, for a time frame, sensor data of the object acquired by a plurality of sensors; generating a two-dimensional bounding box of the object in a projection plane based on the sensor data of the time frame; generating a three-dimensional pose model of the object based on the sensor data of the time frame and a model reconstruction algorithm; generating, based on the sensor data, the pose model, and multiple sampling techniques, a plurality of pose hypotheses of the object corresponding to the time frame, generating a hypothesis projection of the object for each of the pose hypotheses by projecting the pose hypothesis onto the projection plane; determining evaluation results by comparing the hypothesis projections with the bounding box; and determining, based on the evaluation results, an object pose for the time frame.

### CROSS-REFERENCE TO RELATED APPLICATIONS

This application claims priority to and the benefit of U.S. Provisional Application No. 63/514,610, filed on Jul. 20, 2023. The aforementioned application is incorporated herein by reference in its entirety.

### TECHNICAL FIELD

This document describes techniques for determining an object pose of an object, and more specifically methods, apparatuses, and systems for sampling-based object pose determination.

### BACKGROUND

In autonomous driving, the object pose of an object in an environment of an autonomous vehicle may affect an operation of the AV. The object pose may include the location, orientation, and/or size of the object in a three-dimensional space. This information may allow an autonomous vehicle to understand and interact with its surroundings.

### SUMMARY

Autonomous driving technology can enable a vehicle to perform autonomous driving by determining characteristics of an environment of the vehicle including a road where the vehicle is operating, an object located on the road, etc. One or more computers located in the vehicle can determine the characteristics of the environment by performing signal processing on sensor data acquired by multiple sensors located on or in the vehicle. Based on such characteristics of the environment, the vehicle may perceive and interpret the environment, enabling safe and efficient navigation of the vehicle on the road. The accuracy and/or efficiency for the one or more computers to assess the environment and determine and control the vehicle's operations accordingly depends at least in part on the accuracy and/or efficiency of determining the object poses of surrounding objects of the vehicle.

An aspect of the present document relates to a method for determining an object pose of an object. In some embodiments, the method may include obtaining, for a time frame, sensor data of the object acquired by a plurality of sensors; generating a bounding box of the object in a projection plane based on the sensor data of the time frame, in which the bounding box is two-dimensional (2D); generating a pose model of the object based on the sensor data of the time frame and a model reconstruction algorithm, the pose model being three-dimensional (3D) and comprising a set of parameter values of a pose parameter set; generating, based on the sensor data, the pose model, and a plurality of sampling techniques, a plurality of pose hypotheses of the object corresponding to the time frame, generating a hypothesis projection of the object for each of the pose hypotheses by projecting the pose hypothesis onto the projection plane; determining evaluation results by comparing the hypothesis projections with the bounding box; and determining, based on the evaluation results, the object pose for the time frame. The sampling techniques may include at least one of data fusion or data perturbation.

Other aspects of the present document relate to an apparatus for determining an object pose of an object including a processor configured to implement a method as disclosed herein; an autonomous vehicle including such an apparatus; and one or more non-transitory computer readable program storage media having code stored thereon, the code, when executed by a processor, causing the processor to implement a method as disclosed herein.

The above and other aspects and their implementations are described in greater detail in the drawings, the descriptions, and the claims.

### BRIEF DESCRIPTION OF THE DRAWINGS

FIG. 1 shows a block diagram of an example vehicle ecosystem for autonomous driving technology according to some embodiments of the present document.

FIG. 2 shows a top view of an autonomous vehicle that includes a plurality of sensors according to some embodiments of the present document.

FIG. 3 shows a block diagram of an exemplary server configured to determine an object pose according to some embodiments of the present document.

FIG. 4 shows a flowchart of an example process for determining an object pose according to some embodiments of the present document.

FIG. 5 shows an example image of an environment of an autonomous vehicle.

FIG. 6 shows example model reconstruction algorithms, and input and output thereof, according to some embodiments of the present document.

FIGS. 7-9 show example images acquired by cameras of a vehicle and pose hypotheses, as well as evaluation thereof, according to some embodiments of the present document.

### DETAILED DESCRIPTION

An autonomous vehicle (AV) may include sensors (e.g., a camera, a light detection and ranging (LiDAR) sensor, a positioning sensor, a radar sensor, an ultrasonic sensor, a mapping sensor, or the like, or a combination thereof) mounted on or in the autonomous vehicle to obtain sensor data. One or more computers on-board the AV may obtain and analyze the sensor data to determine object poses (e.g., three-dimensional object poses) of objects (e.g., vehicles of various sizes, pedestrians) in an environment in which the autonomous vehicle operates. The object pose of an object may include information regarding the location, orientation, and/or size of the object in a 3D space. In some embodiments, the system may determine an operation instruction for operating an autonomous vehicle by taking into consideration the object pose of an object in an environment of the autonomous vehicle.

According to existing technologies, a processor may determine, based on different image-based depth estimation algorithms, multiple different 3D poses of different qualities for a two-dimensional (2D) bounding box or image data corresponding to an object (e.g., a vehicle or pedestrian in an environment of an autonomous vehicle). This may make it complicated for downstream modules to perform further processing based on the information. For example, to avoid the computational load and/or processing time associated with the application of multiple 3D poses in determining operation parameters of the autonomous vehicle for each time frame (e.g., in an order of 10 or 100 milliseconds), downstream modules may need to choose a 3D pose among the multiple 3D poses for each time frame based on a set of rules (e.g., rules corresponding to conditions and/or scenarios) provided by a user.

Embodiments disclosed in the present document provide methods, apparatuses, and systems for sampling-based determination of an object pose of an object. The system (including, e.g., one or more processors onboard an AV) may determine an object pose of the object for a time frame based solely on sensor data acquired within the time frame, thereby reducing or avoiding the dependencies of the sensor data of multiple time frames and/or the risk of an error or inaccuracy in sensor data or object poses of an object propagating or accumulating over time.

The system may determine one or more pose models of the object based on the sensor data acquired in a time frame, and determine a large number of pose hypotheses of the object (e.g., in the order of 10,000, 100,000, or 1,000,000 pose hypotheses of the object for a time frame) based on the one or more pose models. For example, the processor may generate the pose hypotheses by one or more sampling techniques including, e.g., data fusion, data perturbation, or the like, or a combination thereof. Accordingly, although the number of pose models available may be limited due to one or more factors including the availability of the sensor data, applicable algorithms for generating a pose model based on the sensor data, and/or the associated computational cost and/or processing time, a large number of pose hypotheses may be obtained based on the pose models, thereby increasing the opportunity to obtain an object pose with a desired accuracy.

The system may evaluate the pose hypotheses by comparing them with a reference including, e.g., a two-dimensional bounding box of the object determined based on the sensor data. For example, the processor may generate a two-dimensional hypothesis projection for each of the pose hypotheses, determine a confidence score for each of the pose hypotheses by comparing the corresponding hypothesis projection with the bounding box, and selecting/designating one of the pose hypotheses as the object pose based on the confidence scores. By converting 3D pose hypotheses to 2D hypothesis projections, the system may evaluate the 3D pose hypothesis using corresponding 2D hypothesis projections, thereby reducing the computational cost and/or processing time of the evaluation, and/or allowing a large number of pose hypotheses to be evaluated within an applicable time constraint (e.g., an applicable time constraint for autonomous driving), which in turn may provide improved accuracy in the object pose determination for guiding the autonomous driving.

The system may implement at least a portion of the process for object pose determination in parallel, thereby further reducing the processing time. For example, the system may implement at least a portion of the process in parallel on one or more graphics processing units (GPUs). The system disclosed herein may determine substantially in real time an object pose for each of one or more objects in the environment of an AV such that the system may take such information into consideration when controlling the operation of the AV in the environment over time.

### I. Example Vehicle Ecosystem for Autonomous Driving

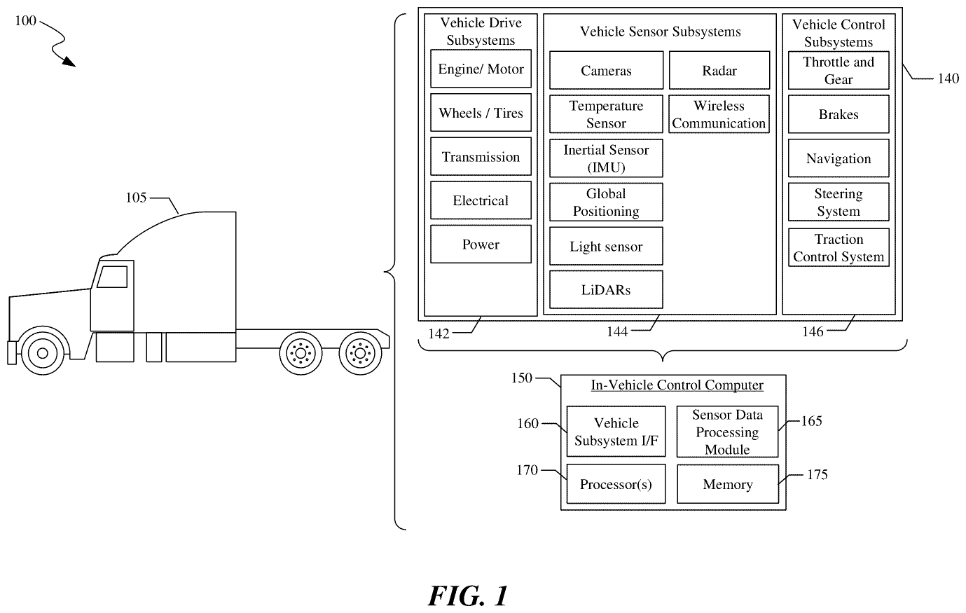

FIG. 1 shows a block diagram of an example vehicle ecosystem 100 for autonomous driving LiDAR technology. The vehicle ecosystem 100 may include an in-vehicle control computer 150 is located in the autonomous vehicle 105. The sensor data processing module 165 of the in-vehicle control computer 150 can perform signal processing techniques on sensor data received from, e.g., one or more of a camera, a light detection and ranging (LiDAR) sensor, a positioning sensor, a radar sensor, an ultrasonic sensor, or a mapping sensor, etc., of (e.g., on or in) the autonomous vehicle 105 so that the signal processing techniques can provide characteristics of objects located on the road where the autonomous vehicle 105 is operated in some embodiments. The sensor data processing module 165 can use at least the information about the characteristics of the one or more objects to send instructions to one or more devices (e.g., motor in the steering system or brakes) in the autonomous vehicle 105 to steer and/or apply brakes.

As exemplified in FIG. 1, the autonomous vehicle 105 may be a truck, e.g., a semi-trailer truck. The vehicle ecosystem 100 may include several systems and components that can generate and/or deliver one or more sources of information/data and related services to the in-vehicle control computer 150 that may be located in an autonomous vehicle 105. The in-vehicle control computer 150 can be in data communication with a plurality of vehicle subsystems 140, all of which can be resident in the autonomous vehicle 105. The in-vehicle computer 150 and the plurality of vehicle subsystems 140 can be referred to as autonomous driving system (ADS). A vehicle subsystem interface 160 is provided to facilitate data communication between the in-vehicle control computer 150 and the plurality of vehicle subsystems 140. In some embodiments, the vehicle subsystem interface 160 can include a controller area network (CAN) controller to communicate with devices in the vehicle subsystems 140.

The autonomous vehicle (AV) 105 may include various vehicle subsystems that support the operation of the autonomous vehicle 105. The vehicle subsystems may include a vehicle drive subsystem 142, a vehicle sensor subsystem 144, and/or a vehicle control subsystem 146. The components or devices of the vehicle drive subsystem 142, the vehicle sensor subsystem 144, and the vehicle control subsystem 146 as shown as examples. In some embodiments, additional components or devices can be added to the various subsystems. Alternatively, in some embodiments, one or more components or devices can be removed from the various subsystems. The vehicle drive subsystem 142 may include components operable to provide powered motion for the autonomous vehicle 105. In an example embodiment, the vehicle drive subsystem 142 may include an engine or motor, wheels/tires, a transmission, an electrical subsystem, and a power source.

The vehicle sensor subsystem 144 may include a number of sensors configured to sense information about an environment in which the autonomous vehicle 105 is operating or a condition of the autonomous vehicle 105. The vehicle sensor subsystem 144 may include one or more cameras or image capture devices, one or more temperature sensors, an inertial measurement unit (IMU), a Global Positioning System (GPS) device, a plurality of LiDARs, one or more radars, one or more ultrasonic sensors, and/or a wireless communication unit (e.g., a cellular communication transceiver). The vehicle sensor subsystem 144 may also include sensors configured to monitor internal systems of the autonomous vehicle 105 (e.g., an O₂ monitor, a fuel gauge, an engine oil temperature, etc.). In some embodiments, the vehicle sensor subsystem 144 may include sensors in addition to the sensors shown in FIG. 1.

The IMU may include any combination of sensors (e.g., accelerometers and gyroscopes) configured to sense position and orientation changes of the autonomous vehicle 105 based on inertial acceleration. The GPS device may be any sensor configured to estimate a geographic location of the autonomous vehicle 105. For this purpose, the GPS device may include a receiver/transmitter operable to provide information regarding the position of the autonomous vehicle 105 with respect to the Earth. Each of the one or more radars may represent a system that utilizes radio signals to sense objects within the environment in which the autonomous vehicle 105 is operating. In some embodiments, in addition to sensing the objects, the one or more radars may additionally be configured to sense the speed and the heading of the objects proximate to the autonomous vehicle 105. The laser range finders or LiDARs may be any sensor configured to sense objects in the environment in which the autonomous vehicle 105 is located using lasers or a light source. The cameras may include one or more cameras configured to capture a plurality of images of the environment of the autonomous vehicle 105. The cameras may be still image cameras or motion video cameras. The ultrasonic sensors may include one or more ultrasound sensors configured to detect and measure distances to objects in a vicinity of the AV 105.

The vehicle control subsystem 146 may be configured to control operation of the autonomous vehicle 105 and its components. Accordingly, the vehicle control subsystem 146 may include various elements such as a throttle and gear, a brake unit, a navigation unit, a steering system and/or a traction control system. The throttle may be configured to control, for instance, the operating speed of the engine and, in turn, control the speed of the autonomous vehicle 105. The gear may be configured to control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more predetermined maps so as to determine the driving path for the autonomous vehicle 105. The steering system may represent any combination of mechanisms that may be operable to adjust the heading of autonomous vehicle 105 in an autonomous mode or in a driver-controlled mode.

In FIG. 1, the vehicle control subsystem 146 may also include a traction control system (TCS). The TCS may represent a control system configured to prevent the autonomous vehicle 105 from swerving or losing control while on the road. For example, TCS may obtain signals from the IMU and the engine torque value to determine whether it should intervene and send instruction to one or more brakes on the autonomous vehicle 105 to mitigate the autonomous vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

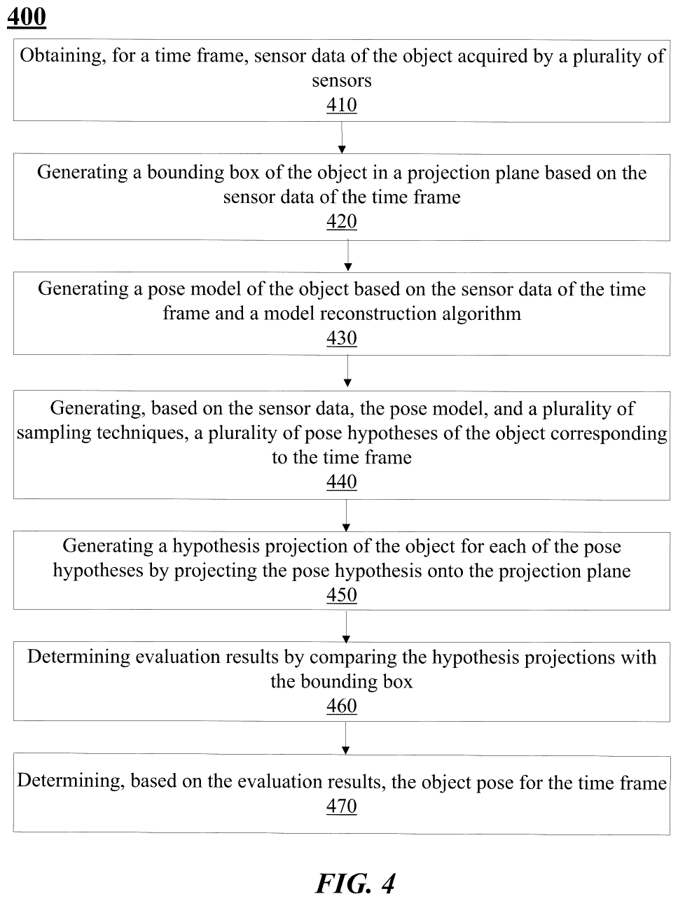

Many or all of the functions of the autonomous vehicle 105 can be controlled by the in-vehicle control computer 150. The in-vehicle control computer 150 may include at least one processor 170 (which can include at least one microprocessor) that executes processing instructions stored in a non-transitory computer readable medium, such as the memory 175. The in-vehicle control computer 150 may also represent a plurality of computing devices that may serve to control individual components or subsystems of the autonomous vehicle 105 in a distributed fashion. In some embodiments, the memory 175 may contain processing instructions (e.g., program logic) executable by the processor 170 to perform various methods and/or functions of the autonomous vehicle 105, including those described for the sensor data processing module 165 as explained in this patent document. For example, the processor 170 of the in-vehicle control computer 150 and may perform operations described in this patent document in, for example, FIGS. 1 and 4.

The memory 175 may contain additional instructions as well, including instructions to transmit data to, receive data from, interact with, or control one or more of the vehicle drive subsystem 142, the vehicle sensor subsystem 144, and the vehicle control subsystem 146. The in-vehicle control computer 150 may control the function of the autonomous vehicle 105 based on inputs received from various vehicle subsystems (e.g., the vehicle drive subsystem 142, the vehicle sensor subsystem 144, and the vehicle control subsystem 146).

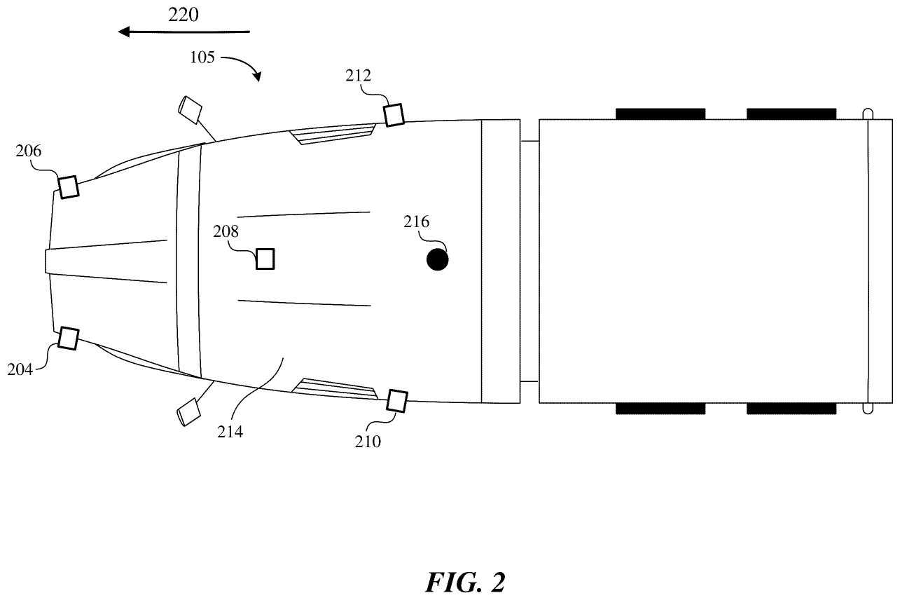

FIG. 2 shows a top view of an autonomous vehicle (AV) 105 that may include a plurality of sensors including LiDARs 204 to 212 and a camera 216. The AV 105 is an example of the AV 105. The locations of the plurality of sensors illustrated in FIG. 2 are exemplary. As shown in FIG. 2, the autonomous vehicle 105 may include a tractor portion of a semi-trailer truck. The camera 216 may be coupled to a roof (or top) of a cab 214 of the autonomous vehicle 105. The plurality of LiDARs 204 to 212 may be located around most or all of the autonomous vehicle 105 so that the LiDARs can obtain sensor data from several areas in front of, next to, and/or behind the autonomous vehicle 105.

The camera 216 may rotate, in a plane parallel to a terrain surface (or road) on which the autonomous vehicle travels, by a rotation angle relative to a forward direction 220 along which the autonomous vehicle travels. The camera 216 may tilt in a vertical plane by a tilt angle relative to the forward direction 220 or tilt by a tilt angle relative to the terrain surface or road. The field of view of the camera 216 of the AV 105 may also depend on the height of the camera 216.

In operation, the AV 105 may monitor its environment including, e.g., the road condition of a terrain surface on which the AV 105 travels, an object travelling in a vicinity of the AV 105 (e.g., within the field of view of the camera 216), and determine or adjust an operation parameter of the AV 105 accordingly. The AV 105 may perform the monitoring based on sensor data acquired by one or more of the plurality of sensors 204-212 and 216 as illustrated in FIG. 2. For instance, the AV 105 may determine a 3D pose of the object based on the sensor data.

### II. Example Server or System for Object Pose Determination

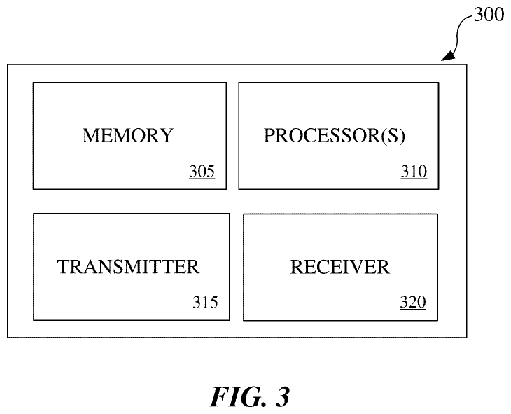

FIG. 3 shows a block diagram of an exemplary server (also referred to as system) configured to determine an object pose according to some embodiments of the present document. The system 300 may include memory 305 and processor(s) 310. The memory 305 may have instructions stored thereupon. The instructions, upon execution by the processor(s) 310, may configure the system 300 (e.g., the various modules of the system 300) to perform the operations described elsewhere in the present document including, e.g., those illustrated in FIGS. 1 and 4. The processor(s) 310 may include at least one graphics processing unit (GPU).

In some embodiments, the system 300 may include a transmitter 315 and a receiver 320 configured to send and receive information, respectively. At least one of the transmitter 315 or the receiver 320 may facilitate communication via a wired connection and/or a wireless connection between the system 300 and a device or information resource external to the system 300. For instance, the system 300 may receive sensor data acquired by sensors of a sensor subsystem 144 via the receiver 320. As another example, the system 300 may receive input from an operator via the receiver 320. As a further example, the system 300 may transmit a notification to a user (e.g., an autonomous vehicle, a display device) via the transmitter 315. In some embodiments, the transmitter 315 and the receiver 320 may be integrated into one communication device.

### III. Example Technique for Object Pose Determination

FIG. 4 shows a flowchart of an example process for determining an object pose according to some embodiments of the present document. The system 300 may perform one or more operations of the process 400.

At 410, the system 300 may receive sensor data that includes information of an object. In some embodiments, the sensor dataset may be acquired by a sensor subsystem (e.g., one or more of components of the sensor subsystem 144 as illustrated in FIG. 1). The system 300 may retrieve the sensor data from a storage device or directly from the sensor subsystem of a vehicle. The sensors may acquire sensor data in a (substantially) synchronized manner. For example, different sensors may acquire sensor data every 100 milliseconds. The AV 105 may include a master clock according to which the sensor data acquisition may be triggered or synchronized periodically (e.g., every minute, every 5 minutes, etc.).

The sensor data may include data acquired by multiple sensors of a same type or different types of the sensor subsystem 144. For instance, the sensor dataset may be acquired by sensors including at least one of a camera, a light detection and ranging (LiDAR) sensor, a positioning sensor, a radar sensor, an ultrasound sensor, or a mapping sensor, or the like, or a combination thereof. As another example, the sensors may include multiple cameras or image capture devices having different fields of view. The sensor data may include a mixture of data acquired by such different sensors. The information of the object depicted in the sensor data may include, e.g., location, size, orientation, or the like, or a combination thereof, of the object, or a portion thereof. The sensor data may be acquired at an acquisition frequency over a period of time, e.g., during the period in which a vehicle traverses an environment including a road on which the AV travels. The acquisition frequency may be in an order of, e.g., 10 Hz (corresponding to a time frame of 100 milliseconds) or 100 Hz (corresponding to a time frame of 10 milliseconds). Merely by way of example, for every 50 or 100 milliseconds, the sensors acquire new sensor data. For an individual time frame, the mixture of sensor data of the object acquired by the different sensors may be registered based on the acquisition time and/or location of the object so that the sensor data of the object that are acquired by different sensors within the same time frame may be grouped for depicting the object.

In some embodiments, the sensor data may have a first spatial accuracy level of 50 centimeters or lower. For example, the sensor dataset may have a first spatial accuracy level of 50 centimeters, 40 centimeters, 30 centimeters, 20 centimeters, 10 centimeters, 8 centimeters, 6 centimeters, 5 centimeters, or below 5 centimeters.

At 420, the system 300 may generate a bounding box of the object in a projection plane based on the sensor data of the time frame. The bounding box may be two-dimensional (2D). The projection plane may be an image plane of an image (part of the sensor data) including the object captured by a camera of the AV. The system 300 may extract bounding box information from at least a portion of the sensor data that is acquired by one or more of the plurality of sensors; and determine the bounding box based on the extracted bounding box information. Example bounding box information include a contour of a representation of the object, one or more feature points (also referred to as key points herein), or the like, or a combination thereof.

For example, the system 300 may determine the bounding box in an image including a representation of the object. The bounding box may include a closed shape in the image enclosing an outer contour of the representation of the object in the image. Examples of the closed shape include a rectangle, a square, a polygon, a circle, an ellipse, etc. For instance, the system 300 may determine the bounding box based on one or more operations including feature recognition, segment, or the like, or a combination thereof.

The bounding box may include one or more feature points. A feature point on the bounding box may correspond to a characteristic point on the object. Examples of such characteristic points on the object may include a wheel, a corner, etc., of the object. The system 300 may identify such key points on the bounding box by image processing techniques including, e.g., feature recognition. In some embodiments, if the sensor data for the time frame includes 3D data (e.g., LiDAR data), the system 300 may identify feature points corresponding to corners of the object on the bounding box.

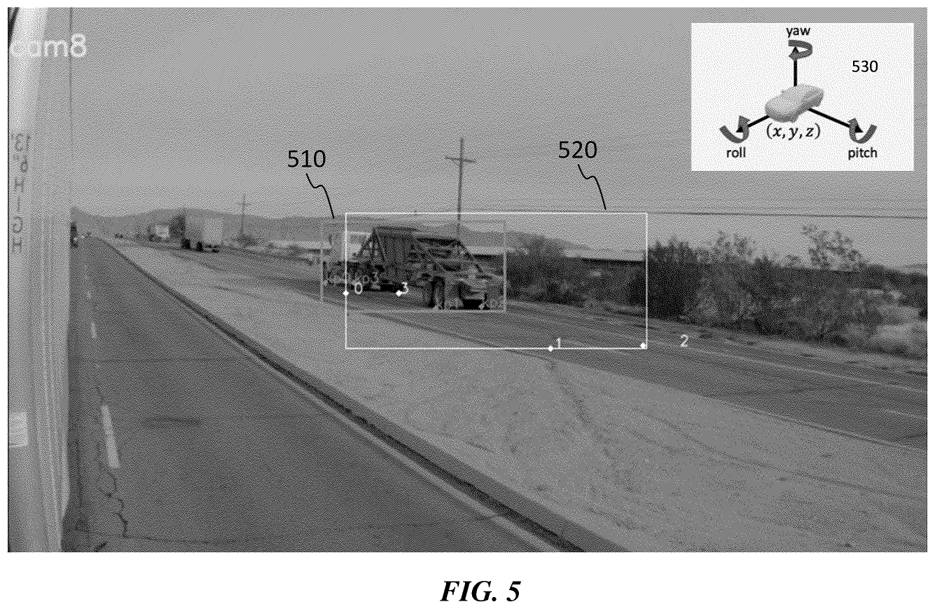

FIG. 5 illustrates an example bounding box 510 that has a shape of a rectangle and encloses the contour of an object, a truck in the example. The bounding box 510 has key points kp0, kp1, kp2, kp3 each of which corresponds to a wheel (e.g., where the wheel contacts the road).

At 430, the system 300 may generate a pose model of the object based on the sensor data of the time frame and a model reconstruction algorithm. The pose model may be three-dimensional (3D) and include a set of parameter values of a pose parameter set. The pose parameter set may include parameters depicting the object in the 3D space. The pose parameter set may include parameters relating to location information, a volume, and/or orientation information of the object. The location information of the object may be described using a set of coordinates (e.g., coordinates x, y, z in the Cartesian coordinate system 530 as illustrated in FIG. 5, or other coordinate systems) that represent its position in space. The Cartesian coordinate system 530 as illustrated has an x-axis that extends along a longitudinal axis or length direction of the object (or the AV 105), a y-axis that is orthogonal to the x-axis and extends along a transverse axis or width direction of the object (or the AV 105), and a z-axis that extends orthogonal to the x- and y-axes through the height of the object (or the AV 105). The coordinate system 530 may be static relative to the AV 105 whose operation is controlled by the system 300.

The volume (also referred to as size) information of the object may be described or approximated by a volume encapsulating a perceived space occupied by the object. In some embodiments, the volume of the object may be described using a length l along the x-axis, a width w along the y-axis, and a height h along the z-axis of the coordinate system 530 of a volume encapsulating a perceived space occupied by the object. In some embodiments, the system 300 may identify an object type of the object based on the sensor data and determine, based on the object type, the volume of the object. Example object types include a pedestrian, a passenger car, a van, or a truck. For example, if the system 300 identifies the object as a truck, the system 300 may assign a volume of 20 meters long (1), 2 meters wide (w), and 3 meters high (h) to the object.

The orientation information of the object may refer to its pose or alignment in the 3D space relative to the AV 105. For example, the orientation information of the object may describe how the object is positioned and oriented with respect to the coordinate system 530. In some embodiments, the orientation of the object may be described using “yaw” as illustrated relative to the coordinate system 530 as illustrated in FIG. 5.

The system 300 may obtain the sensor data acquired by one or more sensors for the time frame. For example, the system 300 may obtain image(s) or video frame(s) captured by one or more cameras for the time frame, process the sensor data using model reconstruction algorithms (e.g., computer vision based model reconstruction algorithms) configured to detect and track the object, extract features, and estimate depth information based on the detected visual cues. By analyzing the object's shape, edges, and key points (also referred to as feature points herein), the system 300 can determine the object's location, volume, and/or orientation in relation to the camera(s)'s field(s) of view and accordingly determine the parameter values of the pose parameter set for the object for the time frame. Sensor data may be processed based on one or more techniques including, e.g., point cloud processing, image recognition, sensor fusion, or the like, or a combination thereof. Merely by way of example, the sensor data includes 2D images, a model reconstruction algorithm for determining a pose model based on the sensor data (e.g., after being processed based on one or more sensor data processing techniques) may be configured to provide a depth estimation based on the 2D images. Examples of such model reconstruction algorithms include a monocular 3D reconstruction algorithm, a stereo reconstruction algorithm, a HD-map guided 3D reconstruction algorithm, or the like, or a combination thereof.

In some embodiments, the system 300 may generate multiple pose models of the object based on the sensor data of the time frame and multiple model reconstruction algorithms. Based on the sensor data, the system 300 may generate multiple pose models of the object with respect to the time frame based on a monocular 3D reconstruction algorithm, a stereo reconstruction algorithm, a projection center reconstruction algorithm, and a projection contour reconstruction algorithm. Merely by way of example, the system 300 may generate a pose model based on a bounding box generated in 420 and an algorithm for depth estimation as exemplified above. Each of the multiple pose models may include parameter values of at least a portion of the pose parameter set.

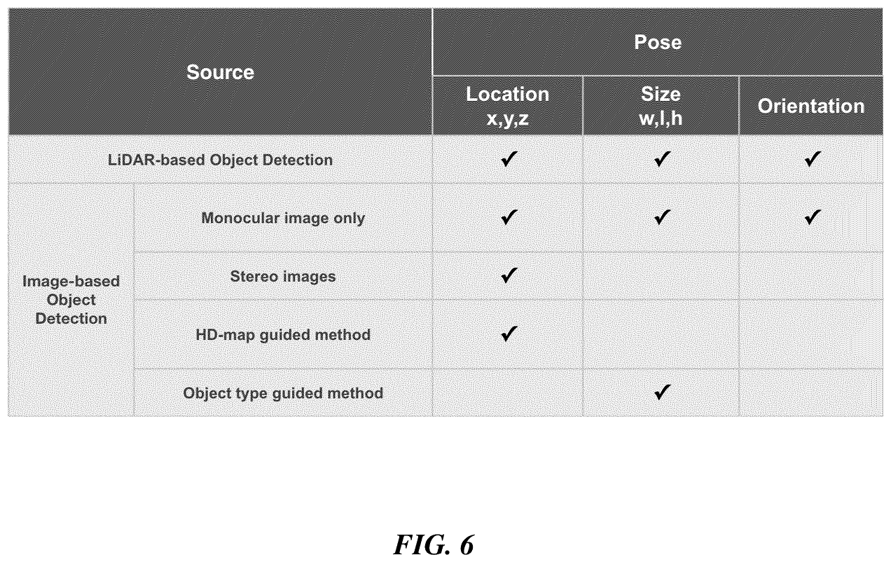

FIG. 6 shows examples of respective sources of sensor data, example model reconstruction algorithms used, and parameter values of the pose parameters available in the respective pose models.

At 440, the system 300 may generate, based on the sensor data, the pose model(s), and a plurality of sampling techniques, a plurality of pose hypotheses of the object corresponding to the time frame. Each of the plurality of pose hypotheses may include a set of parameter values of the pose parameter set depicting a hypothesized 3D pose of the object. Example sampling techniques include data fusion, data perturbation, or the like, or a combination thereof.

The data fusion technique may include combining data for the time frame from different data sources. Example data sources include different sensors, different pose hypotheses, different pose models, etc. According to the data fusion technique, to generate a pose hypothesis, the system 300 may determine parameter values of the pose hypothesis based on at least two of a plurality of data sources including a first portion of the sensor data acquired by a first sensor, a second portion of the sensor data acquired by a second sensor, a first parameter value of a first pose hypothesis, a second parameter value of a second pose hypothesis, a third parameter value of the pose model, or a fourth parameter value of the pose model. The system 300 may combine parameter values of different pose hypotheses, combine parameter values of at least one pose hypothesis and of the pose model, combine the sensor data with at least one parameter value of the pose model, or combine the sensor data with parameter values of at least one pose hypothesis and/or of the pose model.

In some embodiments, according to the data fusion technique, the system 300 may combine data collected by various sensors of the same type (e.g., data acquired by cameras having different fields of view) or different types (e.g., data acquired by one or more camera and one or more LiDAR sensors). To achieve the data fusion, the system 300 can employ techniques including, e.g., sensor data alignment, coordinate transformation, feature extraction, and data integration. The system 300 may determine one or more parameter values of the pose parameter set based on the fused sensor data. The system 300 may use parameter values so determined in one or more pose hypotheses of the object. The system may also apply the fused sensor data in other portions of the process 400 including, e.g., 420 and/or 430.

In some embodiments, the system 300 may retrieve different parameter values for different pose parameters from different data sources (e.g., sensor data acquired by one or more sensors, parameter values from one or more pose hypotheses and/or one or more pose models) and use them as is (without modification) to generate the pose hypothesis. As another example, the system 300 may retrieve different parameter values of a same pose parameter from different data sources and determine, based on the retrieved parameter values, a new parameter value for the pose hypothesis according to one or more operations including, e.g., sum, difference, mean, interpolation, extrapolation, etc.

The data perturbation technique may include synthesizing new data (parameter values of a pose parameter) by perturbing existing data. Data perturbation may involve introducing controlled variations or modifications to the existing data. In some embodiments, to determine a first pose hypothesis, the system 300 may determine a parameter value of a pose parameter of the first pose hypothesis by modifying a parameter value of the pose parameter of another data source including, e.g., at least a portion of the sensor data, a parameter value of the pose parameter of a pose model, a parameter value of the pose parameter of a second pose hypothesis, or the like, or a combination thereof.

For a pose hypothesis, the system 300 may determine parameter values of different pose parameters of the pose parameter set based on different sampling techniques. For example, for a specific pose hypothesis, the system 300 may determine a parameter value of a first pose parameter by fusing data acquired by two different sensors, and a parameter value of a second pose parameter by modifying the parameter value of the second parameter of a pose model or another pose hypothesis. As another example, for a specific pose hypothesis, the system 300 may determine parameter values of a first pose parameter and a second pose parameter by data fusion based on parameter values of a pose model and another pose hypothesis.

The system 300 may generate multiple pose models on the basis of each of which the system 300 may generate multiple pose hypotheses. As illustrated in FIG. 6, a pose model may include parameter values of a subset of the pose parameters of the pose parameter set. For example, the pose model generated based on the stereo model reconstruction algorithm (corresponding to “Stereo images” in FIG. 6) may include location information, but not size or orientation information. When the system 300 generates a pose hypothesis based on such a pose model, the system 300 may use information from another data source (e.g., the size or orientation from the sensor data, parameter values of one or more other pose models, parameter values of one or more other pose hypotheses, etc.) so that the pose hypothesis so generated has parameter values for all the pose parameters of the pose parameter set. In some embodiments, the system 300 may assign a parameter value to a pose parameter that is not available in the pose model. For example, the system 300 may assign a value within a range between 1 degree and 360 degrees, or a portion thereof, as the parameter value for yaw when generating a pose hypothesis based on the pose model that lacks a parameter value for the orientation of the object (e.g., a pose model generated based on a stereo model reconstruction algorithm (corresponding to “Stereo images” in FIG. 6) or a pose model generated based on a HD-map guided algorithm as illustrated in FIG. 6). As another example, the system 300 may assign a parameter value of a pose parameter of the object for the time frame determined for another time frame (e.g., parameter values of one or more pose parameters regarding to a size of the same object based on an understanding that the size of the object remains substantially the same between the two time frames) to the pose parameter of the object for the current time frame. As a further example, the system 300 may assign a parameter value of a pose parameter of the object for the time frame based on the object type (corresponding to “Object type guided method” in FIG. 6). As further illustrated in FIG. 6, a pose model may be generated based solely on monocular images, or based on LiDAR-based object detection, or based on an HD-map guided 3D reconstruction algorithm. A pose model determined based solely on monocular images, or based on LiDAR-based object detection may include parameter values for all the pose parameters (including location, size, and orientation) of the pose parameter set with respect to the object. A pose model determined based on the HD-map guided 3D reconstruction algorithm may include parameter values of the location information of the pose parameter set.

The system 300 may store a set of rules that include multiple sampling techniques and various applications (e.g., different combinations of data sources under data fusion, different controlled variations or modifications for data perturbation) and/or combinations thereof. The system 300 may generate a large number of pose hypotheses by applying the rules to the sensor data, the pose model(s), and/or pose hypotheses generated accordingly. By applying sampling techniques including data fusion, data perturbation, etc., and the corresponding rules, or a combination thereof, the system 300 may create a diverse set of pose hypotheses that capture a broader range of scenarios based on measured sensor data and algorithms applied in the analysis (e.g., point cloud processing, image processing, model reconstruction algorithms, etc.), thereby enhancing the opportunity to identify an optimized object pose.

At 450, the system 300 may generate a hypothesis projection of the object for each of the pose hypotheses by projecting the pose hypothesis onto the projection plane. Example projection algorithms include a perspective projection algorithm. The system 300 may determine projected feature points (also referred to as projected key points) that correspond to the feature points on the bounding box 510. A projected feature point and its corresponding feature point on the bounding box 510 may correspond to a same physical point on the object. For example, the object is a vehicle, and each projected feature point and its corresponding feature point on the bounding box 510 may correspond to one of multiple wheels of the object. As another example, the object is a vehicle, and each projected feature point and its corresponding feature point on the bounding box 510 may correspond to one of multiple corners of the object.

FIG. 5 illustrates an example hypothesis projection, denoted as box 520. The system 300 may generate the hypothesis projection 520 by projecting a pose hypothesis on the projection plane. The hypothesis projection 520 has projected feature points 0, 1, 2, and 3 that correspond to kp0, kp1, kp2, and kp3, respectively.

At 460, the system 300 may determine evaluation results by comparing the hypothesis projections with the bounding box. The evaluation result of a hypothesis projection may include a confidence score that indicates an extent of alignment between the hypothesis projection and the bounding box, which in turn may suggest a quality of the corresponding pose hypothesis.

The system 300 may determine a confidence score for a hypothesis projection (or the corresponding pose hypothesis based on one or more criteria. Example criteria include an overlapping area between the hypothesis projection and the bounding box (e.g., an intersection over union ratio (IoU)), distances between feature points and corresponding projected feature points, or the like, or a combination thereof.

With reference to FIG. 5, the system 300 may determine a confidence score for the hypothesis projection 520 (or the corresponding pose hypothesis) by determining an overlapping area between the hypothesis projection 520 and the bounding box 510, distances between the projected feature points 0, 1, 2, and 3 on the hypothesis projection 520 and kp0, kp1, kp2, and kp3 on the bounding box 510, respectively.

In some embodiments, the system 300 may determine a confidence score based on either one of the overlapping area and the distances, or a combination thereof. For example, the system 300 may determine a first confidence score component based on the overlapping area, and a second confidence score component based on the distances. The system 300 may express the overlapping area as an absolute value, or a dimensionless value (e.g., the absolute value over the area of the bounding box 510). A higher overlapping area may correspond to a higher first confidence score component. The system 300 may express the distances as absolute values, or dimensionless values (e.g., the absolute values over a same reference distance). The system 300 may determine a characteristic distance (e.g., a sum of the distances, an average of the distances, etc.), and determine the second confidence score component based on the characteristic distance. A smaller characteristic distance may correspond to a higher second confidence score component. The system 300 may determine the confidence score based on the first confidence score component and the second confidence score component. For example, the system 300 may determine the confidence score as a sum or a weighted sum of the first confidence score component and the second confidence score component. A higher confidence score may suggest a better quality of the pose hypothesis.

In some embodiments, the system 300 may perform a screening of pose hypotheses based on the confidence scores or the evaluation results. For example, the system 300 may identify, from the plurality of pose hypotheses, a discard group including one or more pose hypotheses each of which satisfies a discard condition. Example discard conditions include that the overlapping area of a hypothesis projection is below an overlapping area threshold, that the characteristic distance of a hypothesis projection is below a distance threshold, that the confidence score of a hypothesis projection is below a confidence score threshold, or the like, or a combination thereof. The system 300 may discard the discard group from further processing, e.g., from being analyzed in 470 below.

At 470, the system 300 may determine, based on the evaluation results, the object pose for the time frame. In some embodiments, the system 300 may determine the object pose for the object for the time frame based on the confidence scores. For example, the system 300 may identify a highest confidence score from the confidence scores the system 300 determines for the pose hypotheses; and designate the pose hypothesis corresponding to the highest confidence score as the object pose.

The system 300 may perform at least a portion of the process 400 by parallel processing. In some embodiments, the system 300 may perform at least one operation of generating the plurality of pose hypotheses at 440 or generating the hypothesis projections at 450 in parallel. For example, the system 300 may generate multiple pose hypotheses (substantially) simultaneously at 440. As another example, the system 300 may generate multiple hypothesis projections simultaneously at 450. As a further example, operations 440 and 450 may proceed (substantially) simultaneously such that the system 300 may start 450 by processing a batch of pose hypotheses generated at 440 while the system 300 continues generating another batch of pose hypotheses at 440. The system 300 may perform at least a portion of the process 400 on one or more GPUs.

Merely by way of example, for a time frame (e.g., 100 milliseconds), there may be tens of or hundreds of objects in the environment of the AV observed by multiple cameras on the AV and recorded as sensor data (in the form of image data). Due to the large number of different pose models and a plurality of sampling techniques employed, the system 300 may generate, based on the image data captured by the multiple cameras for the time frame, over one million pose hypotheses (e.g., 2 million pose hypotheses) for the objects in the environment of the AV. The determination of the projections and subsequent evaluation thereof may take 1 to 2 seconds if the operations (e.g., computations) are performed on CPUs, which is unacceptably long for the purposes of operating the AV. Instead, according to embodiments of the present document, the system 300 may use a parallel computing technique to carry out the operations on GPUs. Considering that each GPU has thousands of threads that can execute a same or similar operation simultaneously, the overall processing time can be reduced to less than 50 milliseconds, which is approximately 20-40 times faster than an implementation on CPUs (which may take 1 to 2 seconds). By significantly improving the processing time, the system 300 may perform real-time control of the autonomous vehicle.

The system 300 may apply the object pose in determining an operation instruction for operating the autonomous vehicle. The sensor data may depict an environment of the autonomous vehicle that includes the object, and the system 300 may determine an operation instruction for operating the autonomous vehicle by taking into consideration of the object pose determined based on the sensor data. For example, the system 300 may determine a distance between the AV and the object, a speed of the object (e.g., based on the location information represented in a series of object poses of the object over time), the position of the AV or the object relative to other objects in the environment, or the like, or a change thereof over time, or a combination thereof; the system 300 may determine an operation instruction for operating the autonomous vehicle accordingly.

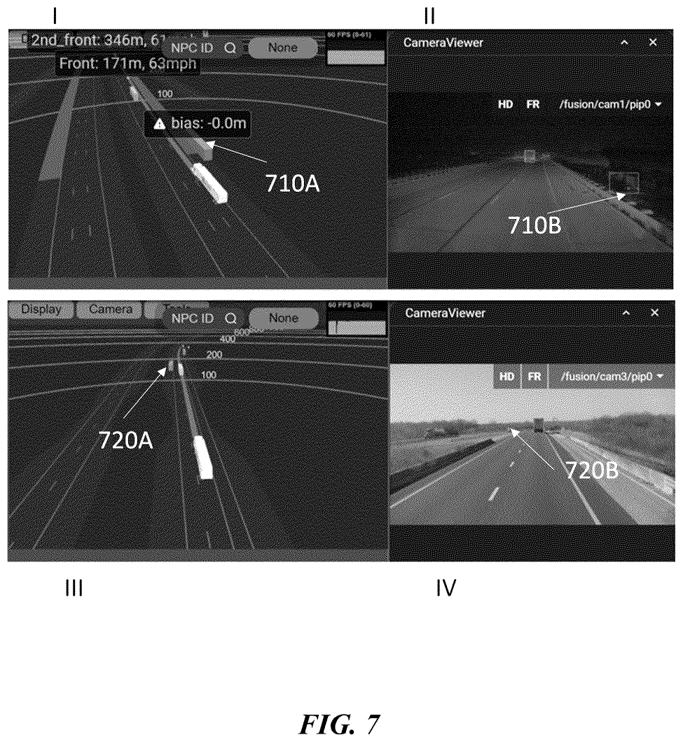

FIGS. 7-9 shows example images acquired by cameras of a vehicle and pose hypotheses, as well as evaluation thereof, according to some embodiments of the present document.

In FIG. 7, panel II shows an image depicting an environment of an AV having one or more cameras. A truck on a lower level of the road is depicted using a bounding box 710B. In panel I, a pose hypothesis 710A of the truck is inaccurate. According to the method disclosed herein, the hypothesis projection (corresponding to a pose hypothesis) 710A may receive a low confidence score due to, e.g., at least a low (or zero) overlapping area (e.g., low (or zero) intersection over union ratio (IoU)). Panel IV shows an object (e.g., a vehicle) operating in an opposite direction (compared to an AV where the camera was installed) as depicted using a bounding box 720B. In panel III, a pose hypothesis 720A of the object is inaccurate. According to the method disclosed herein, the pose hypothesis and the corresponding hypothesis projection 720A may receive a low confidence score due to, e.g., at least a low (or zero) overlapping area (e.g., low (or zero) IoU).

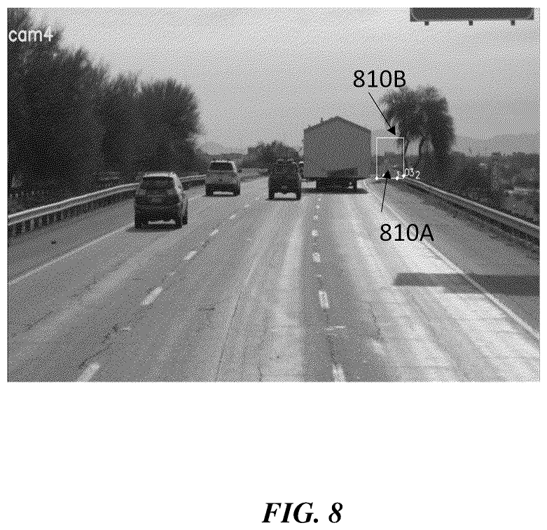

FIG. 8 shows an image depicting an environment of an AV having one or more cameras. Box 810A is a bounding box corresponding to an object in the environment of the AV represented in the image. Box 810B is a projection of a pose hypothesis depicting the object determined according to some embodiments of the present document. The pose hypothesis is deemed inaccurate because it wrongly estimates the object to be much nearer to the AV than it actually is. Thus, its projection 810B is much larger than the actual bounding box 810A. According to the method disclosed herein, the pose hypothesis and the corresponding hypothesis projection 810B may receive a low confidence score due to, e.g., at least a low overlapping area between the bounding box 810A and the projection 810B (e.g., a low IoU). According to some embodiments of the present document, a distance between each of a plurality of projected feature points on the projection 810B and the corresponding feature point on the bounding box 810A may also be determined and used to evaluate the pose hypothesis corresponding to the projection 810B, either alone or in combination with the IoU.

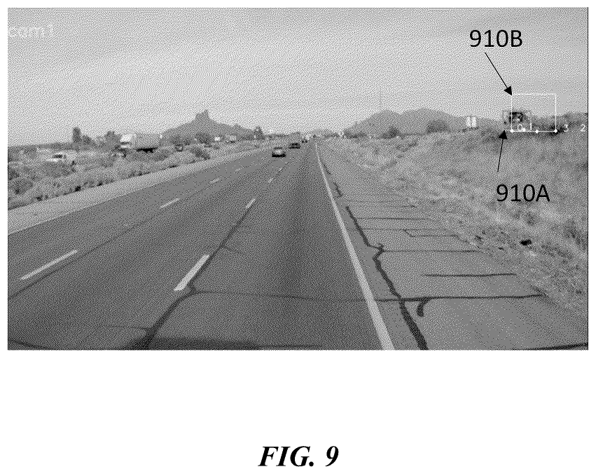

FIG. 9 shows an image depicting an environment of an AV having one or more cameras. Box 910A is a bounding box corresponding to an object in the environment of the AV represented in the image. Box 910B is a projection of a pose hypothesis depicting the object determined according to some embodiments of the present document. The pose hypothesis is deemed inaccurate because it wrongly estimates the object to be much nearer to the AV than it actually is. Thus, its projection 910B is much larger than the actual bounding box 910A. According to the method disclosed herein, the pose hypothesis and the corresponding hypothesis projection 910B may receive a low confidence score due to, e.g., at least a low overlapping area between the bounding box 910A and the projection 910B (e.g., a low IoU). According to some embodiments of the present document, a distance between each of a plurality of projected feature points on the projection 910B and the corresponding feature point on the bounding box 910A may also be determined and used to evaluate the pose hypothesis corresponding to the projection 910B, either alone or in combination with the IoU.

It is understood that the description of the present disclosure is provided with reference to an autonomous vehicle or a semi-truck for illustration purposes and not intended to be limiting. The present technology is applicable to assisted driving in operating a conventional vehicle, an electric vehicle, a hybrid vehicle. The vehicle may include a passenger car, a van, a truck, a bus, etc.

Some example technical solutions preferably implemented below.
1. A method for determining an object pose of an object, including: obtaining, for a time frame, sensor data of the object acquired by a plurality of sensors; generating a bounding box of the object in a projection plane based on the sensor data of the time frame, wherein the bounding box is two-dimensional (2D); generating a pose model of the object based on the sensor data of the time frame and a model reconstruction algorithm, the pose model being three-dimensional (3D) and comprising a set of parameter values of a pose parameter set; generating, based on the sensor data, the pose model, and a plurality of sampling techniques, a plurality of pose hypotheses of the object corresponding to the time frame, wherein: each of the plurality of pose hypotheses comprises a set of parameter values of the pose parameter set depicting a hypothesized 3D pose of the object, and the plurality of sampling techniques comprise at least one of data fusion or data perturbation; generating a hypothesis projection of the object for each of the pose hypotheses by projecting the pose hypothesis onto the projection plane; determining evaluation results by comparing the hypothesis projections with the bounding box; and determining, based on the evaluation results, the object pose for the time frame.
2. A method for determining an object pose of an object, including: obtaining, for a time frame, sensor data of the object acquired by a plurality of sensors; generating a bounding box of the object in a projection plane based on the sensor data of the time frame, wherein the bounding box is two-dimensional (2D); generating one or more pose models of the object based on the sensor data of the time frame and one or more model reconstruction algorithms, each of the one or more pose model being three-dimensional (3D) and comprising a set of parameter values of a pose parameter set; generating a model projection of the object for each of the one or more pose models by projecting the pose model onto the projection plane; determining evaluation results by comparing the model projections with the bounding box; and determining, based on the evaluation results, the object pose for the time frame.
3. A method for determining an object pose of an object, including: obtaining, for a time frame, sensor data of the object acquired by a plurality of sensors; generating a bounding box of the object in a projection plane based on the sensor data of the time frame, wherein the bounding box is two-dimensional (2D); generating a pose model of the object based on the sensor data of the time frame and a model reconstruction algorithm, the pose model being three-dimensional (3D) and comprising a set of parameter values of a pose parameter set; generating, based on the sensor data, the pose model, and a plurality of sampling techniques, a plurality of pose hypotheses of the object corresponding to the time frame, wherein each of the plurality of pose hypotheses comprises a set of parameter values of the pose parameter set depicting a hypothesized 3D pose of the object, and the plurality of sampling techniques comprise at least one of data fusion or data perturbation; and determining the object pose for the time frame by evaluating the pose hypotheses with reference to the bounding box.
4. The method of any one or more solutions herein, wherein the plurality of sensors comprise at least one of a camera, a light detection and ranging (LiDAR) sensor, a positioning sensor, a radar sensor, an ultrasound sensor, or a mapping sensor.
5. The method of any one or more solutions herein, wherein the plurality of sensors comprise multiple cameras having different fields of view.
6. The method of any one or more solutions herein, the object pose is determined based on the sensor data for a single time frame.
7. The method of any one or more solutions herein, wherein the pose parameter set comprises parameters relating to location information, a volume, and/or orientation information of the object.
8. The method of any one or more solutions herein, wherein generating the plurality of pose hypotheses of the object comprises performing an estimation process that includes: determining an object type of the object based on the sensor data; and determining, based on the object type, a parameter value relating to the volume of the object.
9. The method of any one or more solutions herein, wherein the object type comprises a pedestrian, a passenger car, a van, or a truck.
10. The method of any one or more solutions herein, wherein the data perturbation comprises: for a first pose hypothesis of the plurality of pose hypotheses, determining a parameter value of a pose parameter by modifying at least one of: at least a portion of the sensor data, a parameter value of the pose parameter of the pose model, or a parameter value of the pose parameter of a second pose hypothesis of the plurality of pose hypotheses.
11. The method of any one or more solutions herein, wherein the data fusion comprises: for one of the plurality of pose hypotheses, determining parameter values of the pose hypothesis based on at least two of a plurality of data sources comprising: a first portion of the sensor data acquired by a first sensor, a second portion of the sensor data acquired by a second sensor, a first parameter value of a first pose hypothesis, a second parameter value of a second pose hypothesis, a third parameter value of the pose model, or a fourth parameter value of the pose model.
12. The method of any one or more solutions herein, wherein the data fusion comprises: for one of the plurality of pose hypotheses, determining hypothesis values of the pose parameter set of the pose hypothesis by performing at least one of combining parameter values of different pose hypotheses, combining parameter values of at least one pose hypothesis and of the pose model, combining the sensor data with at least one parameter value of the pose model, or combining the sensor data with parameter values of at least one pose hypothesis and/or of the pose model.
13. The method of any one or more solutions herein, wherein the model reconstruction algorithm comprises a monocular 3D reconstruction algorithm, a stereo reconstruction algorithm, a projection center reconstruction algorithm, or a projection contour reconstruction algorithm.
14. The method of any one or more solutions herein, wherein projecting the pose hypothesis onto the projection plane is based on a projection algorithm including at least one of a perspective projection algorithm, an orthographic projection algorithm, or an isometric projection algorithm.
15. The method of any one or more solutions herein, wherein for each of the hypothesis projections, the evaluation result comprises a confidence score that indicates an extent of alignment between the hypothesis projection and the bounding box; and determining the object pose for the object based on the evaluation results comprises identifying, from the plurality of pose hypotheses, the object pose based on the confidence scores.
16. The method of any one or more solutions herein, wherein identifying the object pose comprises: identifying a highest confidence score from the confidence scores; and designating the pose hypothesis corresponding to the highest confidence score as the object pose.
17. The method of any one or more solutions herein, wherein comparing the hypothesis projections with the bounding box comprises: for each of the hypothesis projections, determining an overlapping area between the hypothesis projection and the bounding box; and determining, based on the overlapping area, one of the evaluation results that corresponds to the hypothesis projection.
18. The method of any one or more solutions herein, further comprising: identifying, from the plurality of pose hypotheses, a discard group including one or more pose hypotheses each of which corresponds to a hypothesis projection having an overlapping area below an overlapping area threshold; and discarding the discard group from being identified as the object pose.
19. The method of any one or more solutions herein, wherein comparing the hypothesis projections with the bounding box comprises: for each of the hypothesis projections, obtaining a plurality of feature points on the bounding box; obtaining a plurality of projected feature points on the hypothesis projection that correspond to the plurality of feature points, respectively; determining a distance between each of the plurality of projected feature points and the corresponding feature point; and determining, based on the plurality of distances, one of the evaluation results that corresponds to the hypothesis projection.
20. The method of any one or more solutions herein, wherein the plurality of feature points correspond to at least one of a wheel or a corner point on the object.
21. The method of any one or more solutions herein, wherein comparing the hypothesis projections with the bounding box comprises: for each of the hypothesis projections, determining an overlapping area between the hypothesis projection and the bounding box; and obtaining a plurality of feature points on the bounding box; obtaining a plurality of projected feature points on the hypothesis projection that correspond to the plurality of feature points, respectively; determining a distance between each of the plurality of projected feature points and the corresponding feature point; and determining, based on the plurality of distances and the overlapping area, one of the evaluation results that corresponds to the hypothesis projection.
22. The method of any one or more solutions herein, wherein generating the bounding box comprises: extracting bounding box information from at least a portion of the sensor data that is acquired by one or more of the plurality of sensors; and determining the bounding box based on the extracted bounding box information.
23. The method of any one or more solutions herein, wherein at least one operation of generating the plurality of pose hypotheses or generating the hypothesis projections is performed on one or more GPUs.
24. The method of any one or more solutions herein, wherein at least one operation of generating the plurality of pose hypotheses or generating the hypothesis projections is performed in parallel.
25. The method of any one or more solutions herein, wherein the sensor data depicts an environment of an autonomous vehicle, the method further comprising: determining, based on the object pose, an operation instruction for operating the autonomous vehicle.
26. The method of any one or more of the solutions herein, further comprising: generating a second pose model of the object based on the sensor data of the time frame and a second model reconstruction algorithm, the second pose model being three-dimensional (3D) and comprising a set of parameter values of one or more pose parameters of the pose parameter set; generating, based on the second pose model, a second plurality of pose hypotheses of the object corresponding to the time frame; and generating a hypothesis projection of the object for each of the second plurality of pose hypotheses by projecting the pose hypothesis onto the projection plane, wherein the determining the evaluation results further comprises comparing the hypothesis projections corresponding to the second plurality of pose hypotheses with the bounding box.
27. An apparatus for determining an object pose of an object comprising a processor configured to implement a method of any one or more solutions herein.
28. An autonomous vehicle comprising an apparatus of any one or more solutions herein.
29. The autonomous vehicle of any one or more solutions herein, wherein the apparatus is onboard the autonomous vehicle.
30. One or more non-transitory computer readable program storage media having code stored thereon, the code, when executed by a processor, causing the processor to implement a method of any one or more solutions herein.

Various features and additional details of the above-listed solutions are disclosed throughout the present document including description of FIGS. 1 to 9.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method for determining an object pose of an object, comprising:
obtaining, for a time frame, sensor data of the object acquired by a plurality of sensors;
generating a bounding box of the object in a projection plane based on the sensor data of the time frame, wherein the bounding box is two-dimensional (2D);
generating a pose model of the object based on the sensor data of the time frame and a model reconstruction algorithm, the pose model being three-dimensional (3D) and comprising a set of parameter values of a pose parameter set;
generating, based on the sensor data, the pose model, and a plurality of sampling techniques, a plurality of pose hypotheses of the object corresponding to the time frame, wherein:
each of the plurality of pose hypotheses comprises a set of parameter values of the pose parameter set depicting a hypothesized 3D pose of the object, and
the plurality of sampling techniques comprises at least one of data fusion or data perturbation;
generating a hypothesis projection of the object for each of the plurality of pose hypotheses by projecting the pose hypothesis onto the projection plane;
determining evaluation results by comparing the hypothesis projections with the bounding box; and
determining, based on the evaluation results, the object pose for the time frame.

2. The method of claim 1, wherein the plurality of sensors comprises at least one of a camera, a light detection and ranging (LiDAR) sensor, a positioning sensor, a radar sensor, an ultrasound sensor, or a mapping sensor.

3. The method of claim 1, wherein the plurality of sensors comprises multiple cameras having different fields of view.

4. The method of claim 1, wherein the pose parameter set comprises parameters relating to location information, a volume, and/or orientation information of the object.

5. The method of claim 4, wherein generating the plurality of pose hypotheses of the object comprises performing an estimation process that includes:
determining an object type of the object based on the sensor data; and
determining, based on the object type, a parameter value relating to the volume of the object.

6. The method of claim 1, wherein the data perturbation comprises: for a first pose hypothesis of the plurality of pose hypotheses, determining a parameter value of a pose parameter by modifying at least one of: at least a portion of the sensor data, a parameter value of the pose parameter of the pose model, or a parameter value of the pose parameter of a second pose hypothesis of the plurality of pose hypotheses.

7. The method of claim 1, wherein the data fusion comprises: for one of the plurality of pose hypotheses, determining hypothesis values of the pose parameter set of the pose hypothesis by performing at least one of
combining parameter values of different pose hypotheses,
combining parameter values of at least one pose hypothesis and of the pose model,
combining the sensor data with at least one parameter value of the pose model, or
combining the sensor data with parameter values of at least one pose hypothesis and/or of the pose model.

8. The method of claim 1, wherein the model reconstruction algorithm comprises a monocular 3D reconstruction algorithm, a stereo reconstruction algorithm, or a HD-map guided 3D reconstruction algorithm.

9. The method of claim 1, wherein projecting the pose hypothesis onto the projection plane is based on a projection algorithm including at least one of a perspective projection algorithm, an orthographic projection algorithm, or an isometric projection algorithm.

10. The method of claim 1, wherein for each of the hypothesis projections,
the evaluation result comprises a confidence score that indicates an extent of alignment between the hypothesis projection and the bounding box; and
determining the object pose for the object based on the evaluation results comprises identifying, from the plurality of pose hypotheses, the object pose based on the confidence scores.

11. The method of claim 1, wherein comparing the hypothesis projections with the bounding box comprises: for each of the hypothesis projections,
determining an overlapping area between the hypothesis projection and the bounding box; and
determining, based on the overlapping area, one of the evaluation results that corresponds to the hypothesis projection.

12. The method of claim 11, further comprising:
identifying, from the plurality of pose hypotheses, a discard group including one or more pose hypotheses each of which corresponds to a hypothesis projection having an overlapping area below an overlapping area threshold; and
discarding the discard group from being identified as the object pose.

13. The method of claim 1, wherein comparing the hypothesis projections with the bounding box comprises: for each of the hypothesis projections,
obtaining a plurality of feature points on the bounding box;
obtaining a plurality of projected feature points on the hypothesis projection that correspond to the plurality of feature points, respectively;
determining a distance between each of the plurality of projected feature points and the corresponding feature point; and
determining, based on the plurality of distances, one of the evaluation results that corresponds to the hypothesis projection.

14. The method of claim 1, wherein comparing the hypothesis projections with the bounding box comprises: for each of the hypothesis projections,
determining an overlapping area between the hypothesis projection and the bounding box; and
obtaining a plurality of feature points on the bounding box;
obtaining a plurality of projected feature points on the hypothesis projection that correspond to the plurality of feature points, respectively;
determining a distance between each of the plurality of projected feature points and the corresponding feature point; and
determining, based on the plurality of distances and the overlapping area, one of the evaluation results that corresponds to the hypothesis projection.

15. The method of claim 1, wherein at least one operation of generating the plurality of pose hypotheses or generating the hypothesis projections is performed on one or more GPUs.

16. The method of claim 1, wherein at least one operation of generating the plurality of pose hypotheses or generating the hypothesis projections is performed in parallel.

17. The method of claim 1, wherein the sensor data depicts an environment of an autonomous vehicle, the method further comprising:
determining, based on the object pose, an operation instruction for operating the autonomous vehicle.

18. The method of claim 1, further comprising:
generating a second pose model of the object based on the sensor data of the time frame and a second model reconstruction algorithm, the second pose model being three-dimensional (3D) and comprising a set of parameter values of one or more pose parameters of the pose parameter set;
generating, based on the second pose model, a second plurality of pose hypotheses of the object corresponding to the time frame; and
generating a hypothesis projection of the object for each of the second plurality of pose hypotheses by projecting the pose hypothesis onto the projection plane,
wherein the determining the evaluation results further comprises comparing the hypothesis projections corresponding to the second plurality of pose hypotheses with the bounding box.

19. An apparatus for determining an object pose of an object comprising:
one or more processors; and
one or more non-transitory, computer-readable media comprising instructions that, when executed by the one or more processors, cause operations comprising:
obtaining, for a time frame, sensor data of the object acquired by a plurality of sensors;
generating a bounding box of the object in a projection plane based on the sensor data of the time frame, wherein the bounding box is two-dimensional (2D);
generating a pose model of the object based on the sensor data of the time frame and a model reconstruction algorithm, the pose model being three-dimensional (3D) and comprising a set of parameter values of a pose parameter set;
generating, based on the sensor data, the pose model, and a plurality of sampling techniques, a plurality of pose hypotheses of the object corresponding to the time frame, wherein:
each of the plurality of pose hypotheses comprises a set of parameter values of the pose parameter set depicting a hypothesized 3D pose of the object, and
the plurality of sampling techniques comprises at least one of data fusion or data perturbation;
generating a hypothesis projection of the object for each of the plurality of pose hypotheses by projecting the pose hypothesis onto the projection plane;
determining evaluation results by comparing the hypothesis projections with the bounding box; and
determining, based on the evaluation results, the object pose for the time frame.

20. An autonomous vehicle comprising an apparatus of claim 19.
